(19) United States
(12) Patent Application Publication
(10) Pub. No.: US 2020/0290218 A1
(43) Pub. Date: Sep. 17, 2020

(54) ROBOT PROTECTING JACKET COMPRISING A BEADED CONNECTION

(71) Applicant: Dürr Systems AG, Bietgheim-Bissingen (DE)

(72) Inventor: Detlev Hannig, Winterbach (DE)

(21) Appl. No.: 16/083,959

(22) PCT Filed: Dec. 23, 2016
(86) PCT No.: PCT/EP2016/002183

§ 371 Date: Sep. 11, 2018

(30) Foreign Application Priority Data
Mar. 14, 2016 (DE) 10 2016 003 080.1

(51) Int. Cl. B25J 19/00

(52) U.S. Cl. CPC B25J 19/0075

(57) ABSTRACT

The disclosure relates to a robot protecting jacket for a coating robot, in particular for a painting robot, comprising a connecting element for form-fittingly fastening the robot protecting jacket, especially for fastening the robot protecting jacket to the coating robot or connecting two adjacent portions of the robot protecting jacket to each other. The disclosure provides for the connecting element to be part of a beaded connection.

### CROSS-REFERENCE TO RELATED APPLICATIONS

This application is a national stage of, and claims priority to, Patent Cooperation Treaty Application No. PCT/EP2016/002183, filed on Dec. 23, 2016, which application claims priority to German Application No. DE 10 2016 003 080.1, filed on Mar. 14, 2016, which applications are hereby incorporated herein by reference in their entireties.

The disclosure relates to a robot protecting jacket for a coating robot (e.g. painting robot).

### BACKGROUND

In modern painting installations for painting motor-vehicle body components, usually multi-axis painting robots with serial kinematics are used in order to guide the rotary atomisers which are used as application devices in highly mobile manner over the component surfaces which are to be painted. During painting operation, there is the risk of soiling of such painting robots by excess coating-agent mist (“overspray”), which can lead to soiling of the motor-vehicle body components which are to be painted, in particular when changing paints, since in extreme cases paint residues of the old paint can drip from the painting robot onto the component surface of the motor-vehicle body components which are to be painted with the new paint.

It is therefore known from the prior art to use what are called robot protecting covers or robot protecting jackets which are made of a disposable material and encase the painting robot. During stoppages, a soiled robot protecting cover can then be replaced by the clean robot protecting cover.

Various fastening methods are known from the prior art for fastening such a robot protecting cover to a painting robot, such as for example hook-and-loop tape, press studs, adhesive tape or elastication means. These known fastening methods however each have specific disadvantages. Thus a hook-and-loop tape if soiled by vaseline or paint loses its property of adhesion and therefore permits only an unreliable connection in a painting installation. Press studs on the other hand form only a pointwise connection, and thus cannot produce a connection all around. Fastening by means of adhesive tape on the other hand has to be done manually and is not reliable. Furthermore, adhesive tape has to be cut up again when the robot protecting cover is removed, as a result of which underlying components of the painting robot may be damaged. Finally, rubber rings can only be used if a structure of the robot protecting cover which runs round completely in a ring is present, which is however often not the case. Furthermore, such rubber rings do not permit exact positioning.

### BRIEF DESCRIPTION OF THE DRAWINGS

FIG. 1 is a schematic representation of a painting robot according to the disclosure with a robot protecting jacket according to the disclosure,

FIG. 2A is a beaded connection according to the disclosure in the engaged state,

FIG. 2B is a beaded connection according to the disclosure in the disengaged state, and

FIGS. 3A,3B are various views of a painting robot with a robot protecting jacket which can be opened in the region of a maintenance flap on the painting robot.

### DETAILED DESCRIPTION

The disclosure provides an improvement to the fastening of a robot protecting jacket to a coating robot (e.g. painting robot).

The disclosure includes the general technical description of using a beaded connection for fastening a robot protecting jacket (e.g. robot protecting cover) to a coating robot (e.g. painting robot). Such beaded connections are known outside the technical field of painting technology, for example from caravans, sailboats, from tent-making or from upholstery, and therefore do not need to be described in detail. At this point it should merely be mentioned that a beaded connection consists of a bead rail and a bead, the bead rail being attached to the one component, while the bead is attached to the other component. To produce a form-fitting connection, the component with the bead is then pressed into the bead rail or is pushed in the longitudinal direction until a form-fitting connection is produced.

The robot protecting jacket according to the disclosure therefore, in line with the prior art, has a connecting element for form-fittingly fastening the robot protecting jacket. The robot protecting jacket according to the disclosure is now distinguished in that this connecting element is part of a beaded connection.

In one variant of the disclosure, the beaded connection serves for connection between the robot protecting jacket on one hand and the coating robot on the other hand. The bead in this case may be attached either to the robot protecting jacket or to the coating robot, while the associated bead rail is attached to the respective other component (robot protecting jacket or coating robot).

In another variant of the disclosure, the beaded connection on the other hand serves to connect two portions of the robot protecting jacket. On the one portion of the robot protecting jacket there is then the bead, while the associated bead rail is located on the other portion of the robot protecting jacket.

In a preferred example of embodiment of the disclosure, the robot protecting jacket has at least two portions which adjoin each other in the mounted state. At the transition point between the two portions of the robot protecting jacket, the two portions are then preferably connected to the coating robot by a beaded connection. For example, this transition between the adjacent portions of the robot protecting jacket in the mounted state may lie at the transition between a robot base and a rotatable robot member. The one portion of the robot protecting jacket is then preferably connected to the robot base by a beaded connection, while the other portion of the robot protecting jacket is preferably connected to the rotatable robot member by means of a beaded connection.

Preferably, the beaded connections of the two adjacent portions of the robot protecting jacket are elongate and run parallel to each other, it being possible for the beaded connections to surround a robot member (e.g. robot base, rotatable robot member) in annular manner.

The coating robot (e.g. painting robot) which is to be protected from soiling as a rule is a multi-axis robot with serial kinematics. The robot preferably has a robot base, which is either arranged in fixed manner or may be movable along a traversing rail. The robot base preferably supports a rotatable robot member which is preferably rotatable about a vertical axis of rotation, this rotatable robot member preferably being arranged on the upper side of the robot base. Furthermore, the coating robot preferably includes a proximal robot arm which is pivotable relative to the rotatable robot member, in particular about a horizontal pivot axis. Furthermore, the coating robot which is to be protected preferably has a distal robot arm which is pivotable relative to the proximal robot arm, in particular about a horizontal pivot axis. Furthermore, the coating robot which is to be protected preferably comprises a conventional robot hand axis with for example three axes, which supports an application device (e.g. rotary atomiser).

The robot protecting jacket according to the disclosure in one example has a plurality of portions which can be connected to each other or to the coating robot by means of a beaded connection. Thus a first portion of the robot protecting jacket in one example is adapted to the form of the robot base and encases the robot base in the mounted state. A second portion of the robot protecting jacket on the other hand in one example is adapted to the external form of the rotatable robot member and of the proximal robot arm, and in the mounted state encases the rotatable robot member and the proximal robot arm. Finally, a third portion of the robot protecting jacket in one example is adapted to the form of the distal robot arm and in the mounted state then encases the distal robot arm. This multi-part configuration of the robot protecting jacket according to the disclosure is also advantageous because the individual portions of the robot protecting jacket can then be replaced individually according to their degree of soiling.

In one example of the disclosure, the robot protecting jacket is impermeable to paint in order to prevent paint residues (“overspray”) from penetrating the robot protecting jacket and soiling the coating robot.

Furthermore, it should be mentioned that the robot protecting jacket in one example may include at least partially flexible material and may have a flexible form, so that the robot protecting jacket can adapt to the external form of various coating robots.

Furthermore, it should be mentioned that the robot protecting jacket preferably, depending on the application, consists of an electrically conductive or insulating material. This is advantageous because paint application in modern painting installations usually takes place with an electrostatic coating-agent charge.

One advantage of the beaded connection according to the disclosure is also the fact that the beaded connection can be disengaged and closed manually and without a tool, so that the robot protecting jacket can be replaced rapidly and simply.

The beaded connection can be produced as with conventional beaded connections by pushing the bead into the bead rail in the longitudinal direction. To disengage the beaded connection, the bead is then pulled out of the bead rail again in the longitudinal direction.

It is however alternatively also possible for the beaded connection to be produced by pressing the bead into the bead rail transversely to the longitudinal direction of the bead rail, as a result of which a latching connection is produced. The beaded connection is then disengaged again, by pulling the bead out of the bead rail transversely to the longitudinal direction of the bead rail and counter to the latching force of the beaded connection.

Furthermore, it should be mentioned that the robot protecting jacket may have a plurality of portions which can be connected to each other in each case in pairs by the beaded connection.

Furthermore, the disclosure also includes a further example of the disclosure which enjoys protection independently of the concept of a beaded connection. Thus this further aspect of the disclosure provides for the robot protecting jacket to permit access to a maintenance area on the encased coating robot. Thus a maintenance flap may be located on the coating robot, which flap is removed for maintenance purposes, so that maintenance work can then be carried out in the interior of the housing. The robot protecting jacket then has in the maintenance area a closable opening which is opened during maintenance and then is closed again.

This opening in the robot protecting jacket may for example be closed by a beaded connection, a zip fastener, one or more press studs or by a hook-and-loop fastener.

The disclosure herein may also be used but may also be used with other robots in a paint booth, for example a handling robot (e.g. hood opener, door opener) with such a robot protecting jacket.

It has already been mentioned above that the robot protecting jacket is preferably in several parts and in particular in three parts, with a first portion encasing the robot base, while a second portion of the robot protecting jacket encases the rotatable robot member and the proximal robot arm, whereas a third portion of the robot protecting jacket encases the distal robot arm.

The beaded connection may in this case for example be used in order to connect portions of the robot protecting jacket which are adjacent in pairs in each case to each other. Alternatively, there is however the possibility of the beaded connection also being used to connect a portion of the robot protecting jacket to the coating robot.

In both cases, the beaded connection may be ring-shaped and surround a robot member (e.g. robot base, rotatable robot member, proximal robot arm, distal robot arm) in ring-like manner.

Finally, it should also be mentioned that the disclosure also claims protection for the novel use of a beaded connection for form-fittingly connecting a robot protecting jacket to another component, in particular to the coating robot or to an adjacent robot protecting jacket.

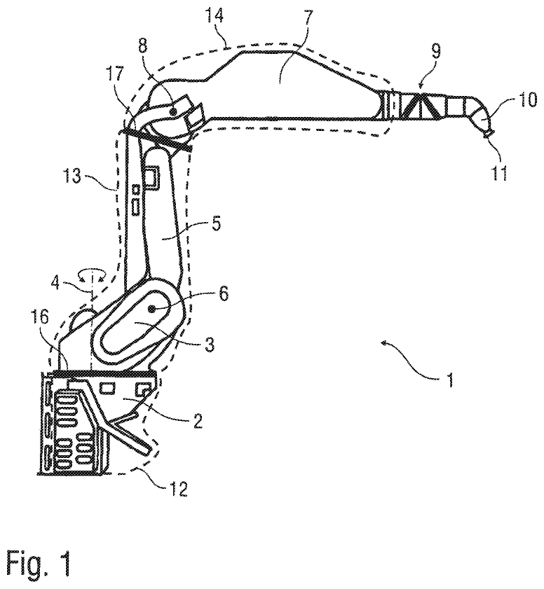

FIG. 1 shows a conventional painting robot 1 which may be used for example in a painting installation in order to paint motor-vehicle body components.

The painting robot 1 has first of all a robot base 2 which is either mounted in fixed manner or is movable at right-angles to the plane of the drawing along a traversing rail.

The robot base 2 supports on its upper side a rotatable robot member 3 which is rotatable relative to the robot base 2 about a vertical axis of rotation 4.

The rotatable robot member 3 in turn supports a proximal robot arm 5 which is pivotable relative to the rotatable robot member 3 about a horizontal pivot axis 6.

A distal robot arm 7 is pivotably attached to the distal end of the proximal robot arm 5, the distal robot arm 7 being pivotable relative to the proximal robot arm 5 about a horizontal pivot axis 8.

The distal robot arm 7 supports on its end a multi-axis, conventionally designed robot hand axis 9, which supports a rotary atomiser 10 as application device, the rotary atomiser 10 having a rotatable bell cup 11, this being sufficiently known from the prior art, and therefore not needing to be described in greater detail.

During painting operation of the painting robot 1 there is the problem that the painting robot 1 is contaminated by excess coating-agent mist (“overspray”), which occasionally makes costly cleaning necessary.

In order to avoid such contamination, the painting robot 1 is encased with a robot protecting cover which consists of three portions 12, 13, 14.

The portion 12 of the robot protecting jacket encases the robot base 2 in the mounted state.

The portion 13 of the robot protecting jacket encases the rotatable robot member 3 and the proximal robot arm 5 in the mounted state.

The portion 14 of the robot protecting jacket on the other hand encases the distal robot arm 7 in the mounted state.

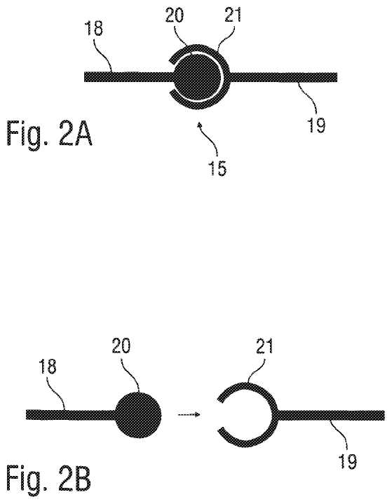

The disclosure is now distinguished in this example of embodiment in that the fastening of the portions 12-14 of the robot protecting jacket to the painting robot 1 takes place by beaded connections 15, as illustrated schematically in FIGS. 2A and 2B.

Two beaded connections 15 in this case are located at a transition 16 from the robot base 2 to the rotatable robot member 3. The portion 12 of the robot protecting jacket is connected to the robot base 2 along this transition 16 by a ring-shaped beaded connection. The portion 13 of the robot protecting jacket is connected to the rotatable robot member 3 at the transition 16 between the robot base 2 and the rotatable robot member 3 by a beaded connection.

The two beaded connections at the transition 16 here run in each case parallel to each other and encompass the robot base 2 or the rotatable robot member 3 in annular manner.

Further beaded connections are located at a transition 17 from the proximal robot arm 5 to the distal robot arm 7. At the transition 17, the portion 14 of the robot protecting jacket is connected to the proximal robot arm 5 by a beaded connection which runs round in a ring shape. The adjoining portion 13 of the robot protecting jacket is connected to the proximal robot arm 5 at the transition 17 likewise by a beaded connection which runs round in a ring shape.

The principle according to the disclosure of the beaded connections 15 can be seen from FIGS. 2A and 2B. Thus the beaded connections 15 permit connection of two components 18, 19 (e.g. two portions of the robot protecting jacket, or robot protecting jacket on one hand and painting robot on the other hand). On the one component 18 there is formed in this case a bead 20 which extends at right-angles to the plane of the drawing. On the other component 19, on the other hand, there is formed a correspondingly adapted bead rail 21, which likewise extends at right-angles to the plane of the drawing.

To produce a form-fitting connection, the two components 18, 19—in a departure from conventional beaded connections—are moved towards each other in the direction of the arrow until the bead 20 engages in the bead rail 21. In order to disengage the beaded connection 15, the two components 18, 19 are therefore pulled apart counter to the direction of the arrow. The robot may include a first portion and a second portion, where a first portion of the jacket generally corresponds to a first portion of robot and a second portion of the jacket generally corresponds to the second portion of the robot. By generally corresponding it is meant that jacket does not loosely hang in such a way to cause interference with the intended use of the robot.

Alternatively, the beaded connection 15 can be produced, as with conventional beaded connections, by pushing the bead 20 into the bead rail 21 in the longitudinal direction (i.e. at right-angles to the plane of the drawing). To disengage the beaded connection 15, the bead 20 is then pulled out of the bead rail 21 again in the longitudinal direction.

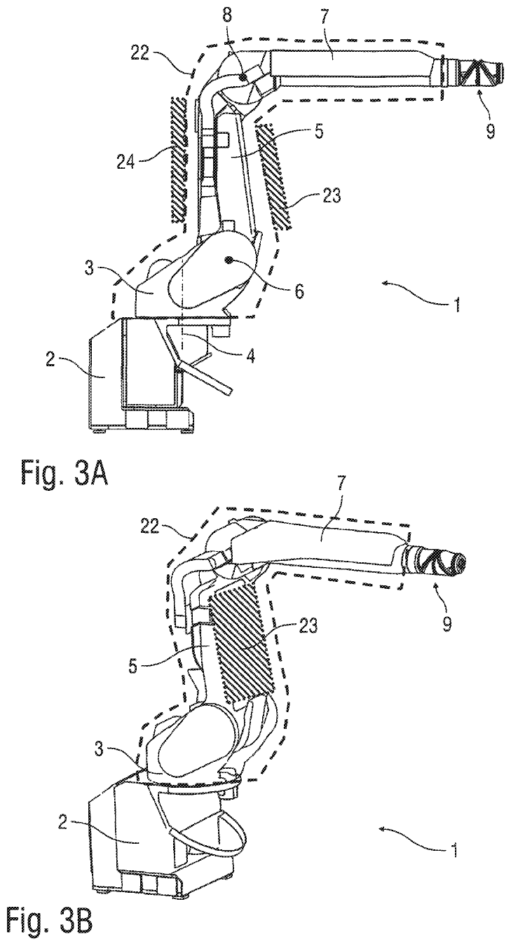

FIGS. 3A and 3B show a modification of FIG. 1, so in order to avoid repetition reference is made to the above description, with the same reference numerals being used for corresponding details.

One special feature of this example of embodiment consists in that the painting robot 1 is enveloped by a robot protecting jacket 22 which has openings 23, 24 in the region of maintenance flaps on the painting robot 1, these openings being represented only schematically as cross-hatched areas in the drawings.

The openings 23, 24 during painting operation are closed by a connecting element (e.g. beaded connection, hook-and-loop fastener, press studs, zip fastener).

For maintenance purposes, the openings 23, 24 in the robot protecting jacket 22 on the other hand are opened and then permit opening of the maintenance flap located underneath on the painting robot 1, so that maintenance work can be carried out in the painting robot 1.

The disclosure not only claims protection for the preferred example of embodiment described above. Rather, the disclosure also claims protection for variants and modifications which likewise make use of the inventive concept and therefore fall within the extent of protection. In particular, the disclosure also claims protection for the subject-matter and the features of the dependent claims independently of the claims referred to in each case.

1.-16. (canceled)

17. A robot protecting jacket for a coating robot the robot including a longitudinal axis, the jacket comprising:
a first portion and a second portion, the first portion generally corresponding to the first portion of the robot and the second portion corresponding to the second portion of the robot, the two portions adjoining each other in a mounted state, and
the first and second portions of the robot protecting jacket being connected on the coating robot by at least one beaded connection.

18. A robot protecting jacket according to claim 17, wherein the connecting element is adapted for fastening the robot protecting jacket to the coating robot.

19. A robot protecting jacket according to claim 17, wherein the beaded connections of the first and second portions of the robot protecting jacket are elongate and run parallel to each other.

20. A robot protecting jacket according to claim 17, wherein the beaded connection has a bead on the robot protecting jacket and a bead rail on the coating robot.

21. A robot protecting jacket according to claim 17, wherein the beaded connection has a bead rail on the robot protecting jacket and a bead on the coating robot.

22. A robot protecting jacket according to claim 17, wherein
a) the robot protecting jacket has at least two portions which adjoin each other in the mounted state on the coating robot, and
b) the two adjacent portions of the robot protecting jacket can be connected to each other at the transition by the beaded connection.

23. A robot protecting jacket according to claim 17, wherein a first portion of the robot protecting jacket is adapted to the form of a robot base of the coating robot.

24. A robot protecting jacked according to claim 23, wherein a second portion of the robot protecting jacket is adapted to the form of one of a rotatable robot member and a proximal robot arm of the coating robot.

25. A robot protecting jacket according to claim 17, wherein the robot protecting jacket is impermeable to paint.

26. A robot protecting jacked according to claim 17, wherein the robot protecting jacket consists of a flexible material and has a flexible form.

27. A robot protecting jacked according to claim 17, wherein the robot protecting jacket consists of an electrically insulating material.

28. A robot protecting jacked according to claim 17, wherein the beaded connection can be disengaged and latched manually and without a tool.

29. A robot protecting jacked according to claim 17, wherein the robot protecting jacket has a plurality of portions which can be connected to each other in each case in pairs by the beaded connection.

30. A robot protecting jacket for a coating robot, further comprising a closable opening in the robot protecting jacket, the opening permitting access to a maintenance area thereunder on the coating robot.

31. A robot protecting jacked according to claim 30, further comprising a connecting element for form-fittingly fastening the robot protecting jacket, wherein the connecting element is part of a beaded connection.

32. A robot protecting jacket according to claim 30, wherein the opening in the robot protecting jacket can be closed by one of the following connection means:
a) zip fastener,
b) beaded connection,
c) press stud,
d) hook-and-loop fastener.
